(19) United States
(12) Patent Application Publication
(10) Pub. No.: US 2025/0151036 A1
(43) Pub. Date: May 8, 2025

(54) MULTI-SLOT RESOURCE ALLOCATION

(71) Applicant: QUALCOMM Incorporated, San Diego, CA (US)

(72) Inventors: Qing LI, Princeton Junction, NJ (US); Giovanni CHISCI, San Diego, CA (US); Chih-Hao LIU, San Diego, CA (US)

(21) Appl. No.: 18/896,220

(22) Filed: Sep. 25, 2024

Related U.S. Application Data
(60) Provisional application No. 63/595,594, filed on Nov. 2, 2023.

(51) Int. Cl. H04W 72/0446; H04W 72/20

(52) U.S. Cl. CPC H04W 72/0446; H04W 72/20

(57) ABSTRACT

Various aspects of the present disclosure generally relate to wireless communication. In some aspects, a user equipment (UE) may perform a listen-before-talk (LBT) process for a multi-slot resource that includes a plurality of consecutive slots. The UE may transmit, based at least in part on the LBT process, a first transport block within a slot of the multi-slot resource in accordance with a first sidelink grant that includes the multi-slot resource. The UE may assign one or more other slots of the multi-slot resource to a second sidelink grant for transmitting a second transport block. Numerous other aspects are described.

### CROSS-REFERENCE TO RELATED APPLICATION

This patent application claims priority to U.S. Provisional Patent Application No. 63/595,594, filed on Nov. 2, 2023, entitled “MULTI-SLOT RESOURCE ALLOCATION,” and assigned to the assignee hereof. The disclosure of the prior application is considered part of and is incorporated by reference into this patent application.

### FIELD OF THE DISCLOSURE

Aspects of the present disclosure generally relate to wireless communication and specifically relate to techniques, apparatuses, and methods for multi-slot resource allocation.

### DESCRIPTION OF RELATED ART

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

In some aspects, a method of wireless communication performed by a user equipment (UE) includes performing a listen-before-talk (LBT) process for a multi-slot resource that includes a plurality of consecutive slots; transmitting, based at least in part on the LBT process, a first transport block within a slot of the multi-slot resource in accordance with a first sidelink grant that includes the multi-slot resource; and assigning one or more other slots of the multi-slot resource to a second sidelink grant for transmitting a second transport block.

In some aspects, an apparatus for wireless communication includes one or more memories; and one or more processors coupled to the one or more memories, the one or more processors individually or collectively configured to: perform an LBT process for a multi-slot resource that includes a plurality of consecutive slots; transmit, based at least in part on the LBT process, a first transport block within a slot of the multi-slot resource in accordance with a first sidelink grant that includes the multi-slot resource; and assign one or more other slots of the multi-slot resource to a second sidelink grant for transmitting a second transport block.

In some aspects, a non-transitory computer-readable medium storing a set of instructions for wireless communication includes one or more instructions that, when executed by one or more processors of a UE, cause the UE to: perform an LBT process for a multi-slot resource that includes a plurality of consecutive slots; transmit, based at least in part on the LBT process, a first transport block within a slot of the multi-slot resource in accordance with a first sidelink grant that includes the multi-slot resource; and assign one or more other slots of the multi-slot resource to a second sidelink grant for transmitting a second transport block.

In some aspects, an apparatus for wireless communication includes means for performing an LBT process for a multi-slot resource that includes a plurality of consecutive slots; means for transmitting, based at least in part on the LBT process, a first transport block within a slot of the multi-slot resource in accordance with a first sidelink grant that includes the multi-slot resource; and means for assigning one or more other slots of the multi-slot resource to a second sidelink grant for transmitting a second transport block.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and the accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network in accordance with the present disclosure.

FIG. 2 is a diagram illustrating an example network node in communication with an example user equipment (UE) in a wireless network.

FIG. 3 is a diagram illustrating an example of sidelink communications, in accordance with the present disclosure.

FIG. 4 is a diagram illustrating an example of a sidelink grant for a multi-slot resource, in accordance with the present disclosure.

FIG. 5 is a diagram illustrating an example of multi-slot resource allocation, in accordance with the present disclosure.

FIG. 6 is a diagram illustrating an example of a multi-slot resource, in accordance with the present disclosure.

FIG. 7 is a diagram illustrating an example process performed, for example, at a UE or an apparatus of a UE, in accordance with the present disclosure.

FIG. 8 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

A channel access process for unlicensed sidelink may be performed in accordance with a listen-before-talk (LBT) operation on a sidelink channel. When a UE obtains a sidelink channel occupancy time (COT) after a successful sidelink LBT operation (such as an LBT operation that uses Type-1 channel access), it may be beneficial for the UE to use the COT for continuous transmissions, for example, since discontinuous transmissions may require the UE to perform additional sidelink LBT channel access operations, which may decrease network throughput. For example, a successful LBT may be delayed in accordance with the network being busy and/or in accordance with competition for channel access between the UE and other devices (such as other UEs or Wi-Fi devices in proximity to the UE). An LBT failure may cause the UE to not be able to complete a transmission in accordance with a grant, which may result in the UE needing to obtain a new grant, which may further reduce network throughput. In some cases, a transmission may be dropped if no successful LBT is obtained within a latency requirement (for example, within a packet delay budget (PDB)), which may reduce the quality of service (QOS) performance.

In some cases, multi-consecutive slot transmissions may be used to increase an efficiency of sidelink communications on a shared spectrum. In a first example, a higher layer (e.g., a medium access control (MAC) layer) may trigger a Layer 1 (L1) candidate resource selection process for a single transport block with a single set of parameters. The L1 may report a set of candidate single-slot resources in accordance with an existing L1 resource allocation procedure. The higher layer may select a set of resources for multi-consecutive-slot transmissions. In a second example, the higher layer (e.g., the MAC layer) may trigger an L1 candidate resource selection for a single transport block with a single set of parameters plus a number of slots for multi-consecutive slot transmissions. The L1 may report a set of candidate multi-slot resources in accordance with some or all of the existing L1 resource allocation processes. The higher layer may select a candidate multi-slot resource for multi-consecutive slot transmissions.

A sidelink grant with selected resource(s) may be associated with a sidelink process by a hybrid automatic repeat request (HARQ) entity corresponding to a HARQ buffer with a single transport block transmission and retransmission or multiple semi-persistent scheduling (SPS) transport block transmissions and retransmissions, respectively. In some cases, a sidelink grant with a selected multi-slot resource may be associated with a sidelink process by a HARQ entity corresponding to a HARQ buffer or data buffer that is for a single transport block transmission and one or more associated retransmissions. In some cases, a sidelink grant for a multi-slot resource may include one or more unused resources (for example, one or more unused slots). For example, the sidelink grant may be assigned a multi-slot resource that includes six slots. A first slot and a second slot of the multi-slot resource may be used for performing an LBT, and a third slot of the multi-slot resource may be used for transmitting a transport block (TB) after a successful LBT procedure. However, the three remaining slots of the multi-slot resource may not be needed or used for transmitting the same TB, and therefore, may be unused by the sidelink UE. In some examples, the unused slots may be used for performing one or more retransmissions of the transport block. However, the retransmissions may not be needed or used, for example, when sidelink channel conditions are reliable. Therefore, multi-consecutive slot transmissions may result in wasted network resources, for example, when the quantity of slots that is assigned to a sidelink grant is greater than a quantity of slots that is needed or used for performing a transmission of a transport block in accordance with the sidelink grant.

Various aspects generally relate to wireless communications. Some aspects more specifically relate to multi-slot resource allocation for sidelink communications. In some aspects, a UE may perform an LBT procedure for a multi-slot resource that includes a plurality of consecutive slots. The UE may perform the LBT procedure for the multi-slot resource in accordance with selecting the multi-slot resource from a multi-slot candidate resource set. The UE may transmit a first transport block within a slot of the multi-slot resource in accordance with a first sidelink grant that includes the multi-slot resource. The UE may transmit the first transport block in accordance with the LBT procedure being successful. In some aspects, a medium access control (MAC) layer of the UE may instruct a physical (PHY) layer of the UE to transmit a physical sidelink control channel (PSCCH) or a physical sidelink shared channel (PSSCH) with the first transport block at an LBT occasion associated with a successful LBT procedure. The UE may assign one or more slots of the multi-slot resource to a second sidelink grant for transmitting a second transport block. For example, after transmitting the first transport block using the slot of the multi-slot resource and in accordance with the first sidelink grant, the UE may reassign one or more remaining slots (for example, one or more slots of the first sidelink grant that occur after the transmission of the first transport block) to the second sidelink grant for transmitting the second transport block. The UE may transmit the second transport block using the one or more slots that have been reassigned to the second sidelink grant. In some aspects, the UE may perform one or more retransmissions of the first transport block prior to reassigning the one or more slots of the multi-slot resource to the second sidelink grant.

Particular aspects of the subject matter described in this disclosure can be implemented to realize one or more of the following potential advantages. In some examples, by transmitting a first transport block using one or more slots of a multi-slot resource and in accordance with a first sidelink grant, and by reassigning one or more other slots of the multi-slot resource to a second sidelink grant, the described techniques can be used to reduce a likelihood of unused transmission resources. For example, by transmitting the first transport block using one or more slots of the multi-slot resource that are assigned to the first sidelink grant, and by reassigning one or more unused slots of the multi-slot resource to the second sidelink grant, the described techniques can be used to increase a likelihood that the one or more unused slots are used for transmitting a second transport block in accordance with the second sidelink grant. In some examples, by transmitting the first transport block in accordance with the first sidelink grant and transmitting the second transport block in accordance with the second sidelink grant using the same multi-slot resource, the described techniques can be used to increase network throughput. In some examples, by identifying whether a retransmission of the first transport block is to be performed, the described techniques can be used to reduce unnecessary retransmissions. For example, by identifying whether blind retransmissions are enabled and/or whether the retransmissions can form a transmission burst, the described techniques can be used to increase a likelihood of a successful transmission of the first transport block while reducing unnecessary retransmissions of the first transport block (e.g., when network conditions satisfy a threshold). In some examples, by transmitting the first transport block in accordance with the first sidelink grant and transmitting the second transport block in accordance with the second sidelink grant using the same multi-slot resource, the described techniques can be used to enable multiple transmissions associated with multiple different sidelink grants to be performed within the same multi-slot resource. These example advantages, among others, are described in more detail below.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (cMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

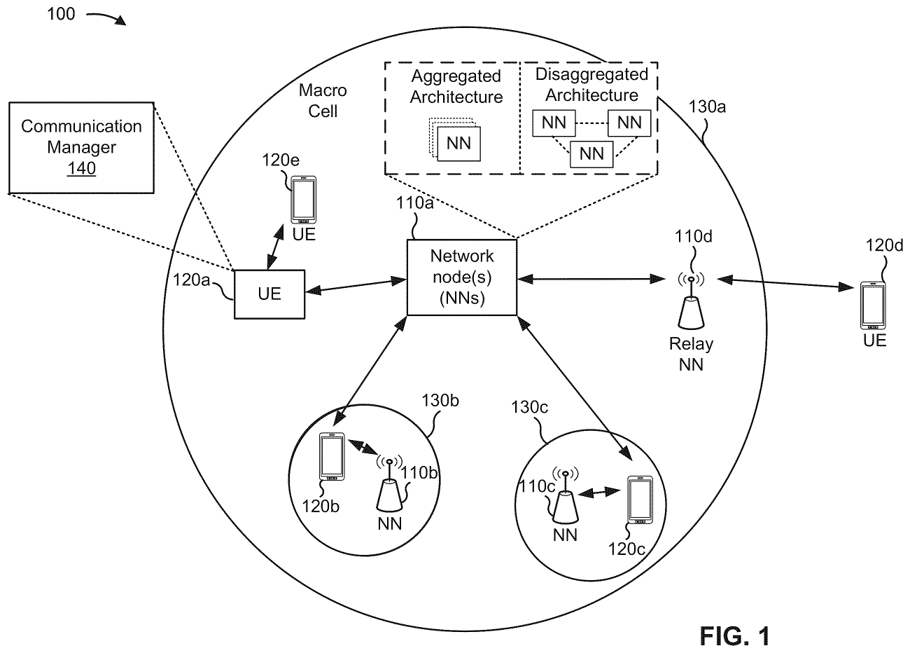

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120c.

The network nodes 110 and the UEs 120 of the wireless communication network 100 may communicate using the electromagnetic spectrum, which may be subdivided by frequency or wavelength into various classes, bands, carriers, or channels. For example, devices of the wireless communication network 100 may communicate using one or more operating bands. In some aspects, multiple wireless networks 100 may be deployed in a given geographic area. Each wireless communication network 100 may support a particular radio access technology (RAT) (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FRI (410 MHz through 7.125 GHZ), FR2 (24.25 GHz through 52.6 GHZ), FR3 (7.125 GHZ through 24.25 GHZ), FR4a or FR4-1 (52.6 GHz through 71 GHZ), FR4 (52.6 GHZ through 114.25 GHZ), and FR5 (114.25 GHz through 300 GHz). Although a portion of FRI is greater than 6 GHz, FRI is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FRI or FR2 into mid-band frequencies. Thus, “sub-6 GHz,” if used herein, may broadly refer to frequencies that are less than 6 GHZ, that are within FRI, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FRI, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a MAC layer, and/or one or more PHY layers depending, at least in part, on a functional split, such as a functional split defined by the 3GPP. In some examples, a DU also may host one or more lower PHY layer functions, such as a fast Fourier transform (FFT), an inverse FFT (IFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or a non-terrestrial network (NTN) network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an extended reality (XR) device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an unmanned aerial vehicle or drone, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of ultra-reliable low-latency communication (URLLC), enhanced mobile broadband (cMBB), and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120c) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some radio access technologies (RATs) may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, the UE 120 may include a communication manager 140. As described in more detail elsewhere herein, the communication manager 140 may perform an LBT process for a multi-slot resource that includes a plurality of consecutive slots; transmit, based at least in part on the LBT process, a first transport block within a slot of the multi-slot resource in accordance with a first sidelink grant that includes the multi-slot resource; and assign one or more other slots of the multi-slot resource to a second sidelink grant for transmitting a second transport block. Additionally, or alternatively, the communication manager 140 may perform one or more other operations described herein.

As indicated above, FIG. 1 is provided as an example. Other examples may differ from what is described with regard to FIG. 1.

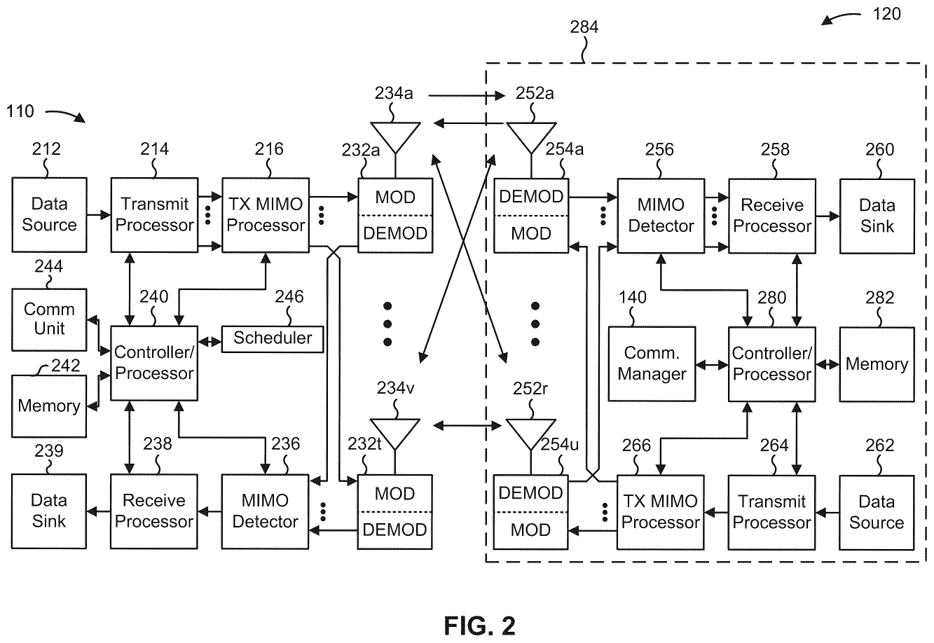

FIG. 2 is a diagram illustrating an example network node 110 in communication with an example UE 120 in a wireless network.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, and/or a scheduler 246, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a channel quality indicator (CQI) parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

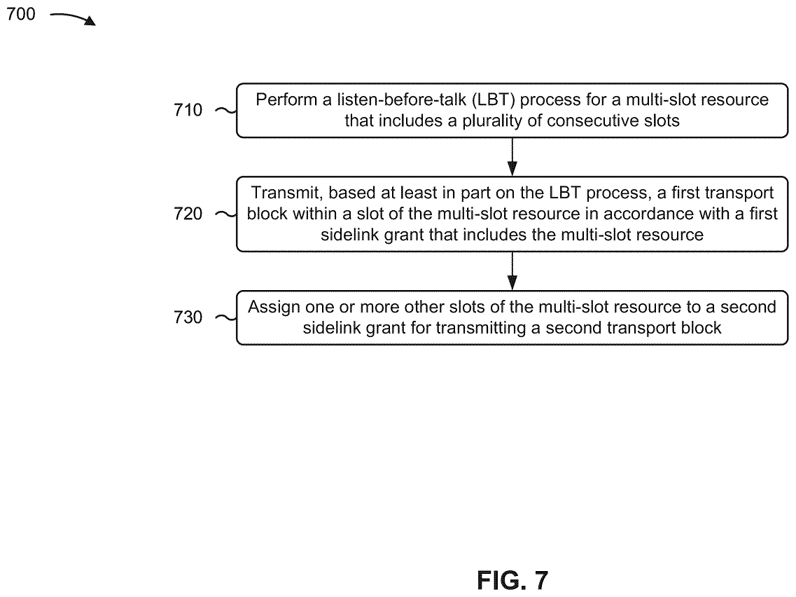

The network node 110, the controller/processor 240 of the network node 110, the UE 120, the controller/processor 280 of the UE 120, or any other component(s) of FIG. 1 or 2 may implement one or more techniques or perform one or more operations associated with multi-slot resource allocation, as described in more detail elsewhere herein. For example, the controller/processor 240 of the network node 110, the controller/processor 280 of the UE 120, or any other component(s) (or combinations of components) of FIG. 2, may perform or direct operations of, for example, process 700 of FIG. 7, or other processes as described herein (alone or in conjunction with one or more other processors). The memory 242 may store data and program codes for the network node 110. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110 or the UE 120 may cause the one or more processors to perform process 700 of FIG. 7, or other processes as described herein. In some examples, executing instructions may include running the instructions, converting the instructions, compiling the instructions, and/or interpreting the instructions, among other examples.

In some aspects, the UE 120 includes means for performing an LBT process for a multi-slot resource that includes a plurality of consecutive slots; means for transmitting, based at least in part on the LBT process, a first transport block within a slot of the multi-slot resource in accordance with a first sidelink grant that includes the multi-slot resource; and/or means for assigning one or more other slots of the multi-slot resource to a second sidelink grant for transmitting a second transport block. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

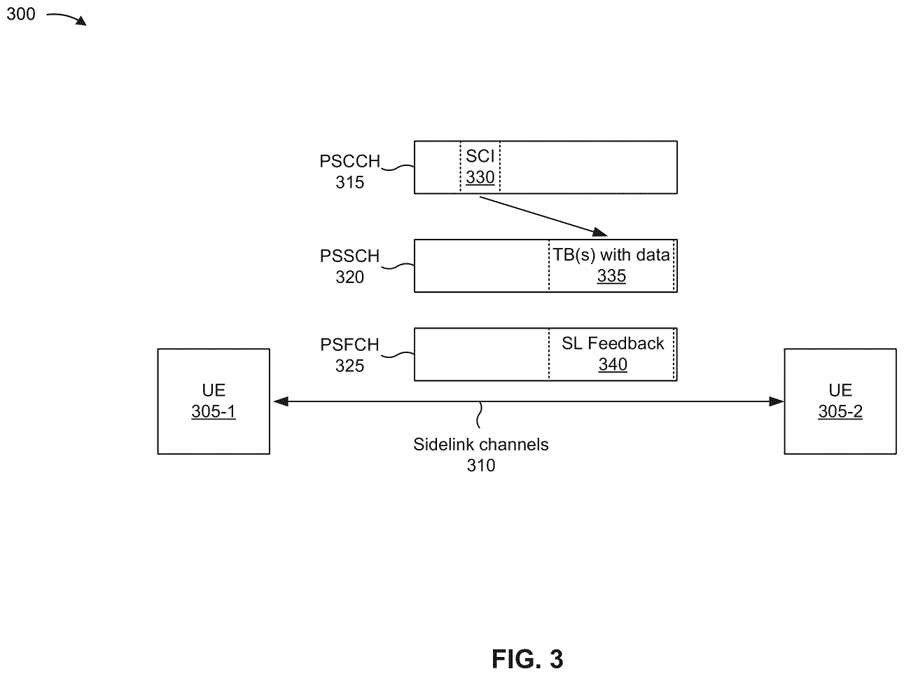

FIG. 3 is a diagram illustrating an example 300 of sidelink communications, in accordance with the present disclosure.

As shown in FIG. 3, a first UE 305-1 may communicate with a second UE 305-2 (and one or more other UEs 305) via one or more sidelink channels 310. The UEs 305-1 and 305-2 may communicate using the one or more sidelink channels 310 for P2P communications, D2D communications, V2X communications (e.g., which may include V2V communications, V2I communications, and/or V2P communications) and/or mesh networking. In some aspects, the UEs 305 (e.g., UE 305-1 and/or UE 305-2) may correspond to one or more other UEs described elsewhere herein, such as UE 120. In some aspects, the one or more sidelink channels 310 may use a PC5 interface and/or may operate in a high frequency band (e.g., the 5.9 GHz band). Additionally, or alternatively, the UEs 305 may synchronize timing of transmission time intervals (TTIs) (e.g., frames, subframes, slots, or symbols) using global navigation satellite system (GNSS) timing.

As further shown in FIG. 3, the one or more sidelink channels 310 may include a PSCCH 315, a PSSCH 320, and/or a physical sidelink feedback channel (PSFCH) 325. The PSCCH 315 may be used to communicate control information, similar to a physical downlink control channel (PDCCH) and/or a physical uplink control channel (PUCCH) used for cellular communications with a network node 110 via an access link or an access channel. The PSSCH 320 may be used to communicate data, similar to a physical downlink shared channel (PDSCH) and/or a physical uplink shared channel (PUSCH) used for cellular communications with a network node 110 via an access link or an access channel. For example, the PSCCH 315 may carry sidelink control information (SCI) 330, which may indicate various control information used for sidelink communications, such as one or more resources (e.g., time resources, frequency resources, and/or spatial resources) where a transport block (TB) 335 may be carried on the PSSCH 320. The TB 335 may include data. The PSFCH 325 may be used to communicate sidelink feedback 340, such as hybrid automatic repeat request (HARQ) feedback (e.g., acknowledgement or negative acknowledgement (ACK/NACK) information), transmit power control (TPC), and/or a scheduling request (SR).

Although shown on the PSCCH 315, in some aspects, the SCI 330 may include multiple communications in different stages, such as a first stage SCI (SCI-1) and a second stage SCI (SCI-2). The SCI-1 may be transmitted on the PSCCH 315. The SCI-2 may be transmitted on the PSSCH 320. The SCI-1 may include, for example, an indication of one or more resources (e.g., time resources, frequency resources, and/or spatial resources) for one or more future transmissions of the PSSCH 320, information for decoding sidelink communications on the PSSCH, a quality of service (QOS) priority value, a resource reservation period, a PSSCH demodulation reference signal (DMRS) pattern, an SCI format for the SCI-2, a beta offset for the SCI-2, a quantity of PSSCH DMRS ports, and/or a modulation and coding scheme (MCS). The SCI-2 may include information associated with data transmissions on the PSSCH 320, such as a hybrid automatic repeat request (HARQ) process ID, a new data indicator (NDI), a source identifier, a destination identifier, and/or a channel state information (CSI) report trigger.

In some aspects, the one or more sidelink channels 310 may use resource pools. For example, a scheduling assignment (e.g., included in SCI 330) on PSCCH 315 may be transmitted together with the data transmission (e.g., on the PSSCH 320) associated with the scheduling assignment.

In some aspects, a UE 305 may operate using a sidelink resource allocation mode (e.g., Mode 1) where resource selection and/or scheduling is performed by a network node 110 (e.g., a base station, a CU, or a DU). For example, the UE 305 may receive a grant (e.g., in downlink control information (DCI) or in a radio resource control (RRC) message, such as for configured grants) from the network node 110 (e.g., directly or via one or more network nodes) for sidelink channel access and/or scheduling. In some aspects, a UE 305 may operate using a sidelink resource allocation mode (e.g., Mode 2) where resource selection and/or scheduling is performed by the UE 305 (e.g., rather than a network node 110). In some aspects, the UE 305 may perform resource selection and/or scheduling by sensing channel availability for transmissions. For example, the UE 305 may measure a received signal strength indicator (RSSI) parameter (e.g., a sidelink-RSSI (S-RSSI) parameter) associated with various sidelink channels, may measure a reference signal received power (RSRP) parameter (e.g., a PSCCH-RSRP or PSSCH-RSRP parameter) associated with various sidelink channels, and/or may measure a reference signal received quality (RSRQ) parameter (e.g., a PSCCH-RSRQ or PSSCH-RSRQ parameter) associated with various sidelink channels, and may select a channel for transmission of a sidelink communication based at least in part on the measurement(s).

Additionally, or alternatively, the UE 305 may perform resource selection and/or scheduling using SCI 330 received in the PSCCH 315, which may indicate occupied resources and/or channel parameters. Additionally, or alternatively, the UE 305 may perform resource selection and/or scheduling by determining a channel busy ratio (CBR) associated with various sidelink channels, which may be used for rate control (e.g., by indicating a maximum number of resource blocks that the UE 305 can use for a particular set of slots).

In the transmission mode where resource selection and/or scheduling is performed by a UE 305, the UE 305 may generate sidelink grants, and may transmit the grants in SCI 330. A sidelink grant may indicate, for example, one or more parameters (e.g., transmission parameters) to be used for an upcoming sidelink transmission, such as one or more resource blocks to be used for the upcoming sidelink transmission on the PSSCH 320 (e.g., for TBs 335), one or more subframes to be used for the upcoming sidelink transmission, and/or a modulation and coding scheme (MCS) to be used for the upcoming sidelink transmission. In some aspects, a UE 305 may generate a sidelink grant that indicates one or more parameters for semi-persistent scheduling (SPS), such as a periodicity of a sidelink transmission. Additionally, or alternatively, the UE 305 may generate a sidelink grant for event-driven scheduling, such as for an on-demand sidelink message.

As indicated above, FIG. 3 is provided as an example. Other examples may differ from what is described with respect to FIG. 3.

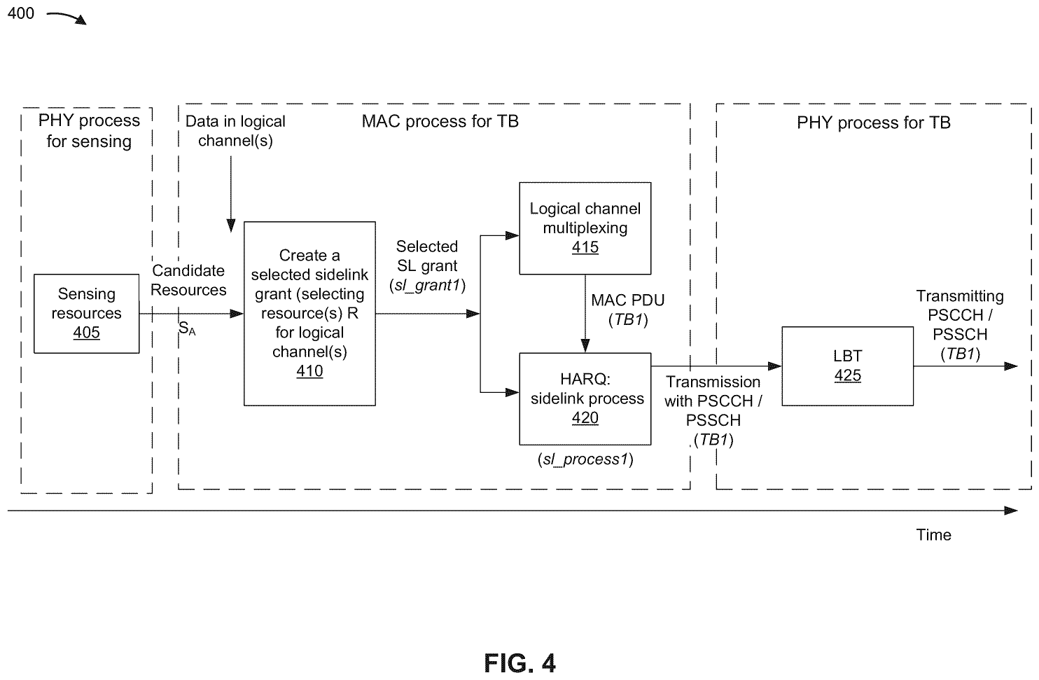

FIG. 4 is a diagram illustrating an example 400 of a sidelink grant for a multi-slot resource, in accordance with the present disclosure.

A channel access process for unlicensed sidelink may be performed in accordance with an LBT procedure that occurs on a sidelink channel (for example, using a PC5 interface) for a sidelink communication associated with a sidelink channel access priority class (SL CAPC). When a UE obtains a sidelink channel occupancy time (COT), for example, after a successful sidelink LBT procedure with a Type-1 LBT channel access process, it may be beneficial for the UE to use the COT for continuous transmissions, for example, since discontinuous transmissions may require the UE to perform a subsequent sidelink LBT procedure with Type-1 LBT channel access process to be performed prior to the discontinuous transmission. Performing the additional Type-1 LBT channel access procedures may decrease network throughput due to the overhead of Type-1 LBT channel access procedures. This may be caused by a delayed successful LBT procedure in accordance with the network being busy, for example, due to competition for channel access between the UE and other devices (such as other UEs or Wi-Fi devices in proximity to the UE). An LBT failure may cause the UE not able to complete a granted transmission, which may result in the UE needing to obtain a new grant, thereby further reducing throughput. In some cases, a transmission may be dropped if no successful LBT result is obtained within a latency requirement (for example, within a PDB), which may degrade QoS performance for the sidelink communication.

In some cases, multi-consecutive-slot transmissions (MCSt) may be used to increase an efficiency of sidelink communications on a shared spectrum. In a first example, a higher layer (e.g., a MAC layer) may trigger an L1 candidate resource selection process for a single transport block with a single set of parameters (e.g., QoS priority prio_{TX}, remaining packet delay budget (PDB), frequent resources in number of subchannels L_{subCH} and resource reservation period P_{rsvp_TX}). The L1 may report a set of candidate single-slot resources (S_{A}) in accordance with an existing L1 resource allocation procedure. The higher layer may select a set of resources for MCSt. In a second example, a higher layer (e.g., the MAC layer) may trigger an L1 candidate resource selection for a single transport block with a single set of parameters (prio_{TX}, remaining PDB, L_{subCH} and P_{rsvp_TX}) plus a “number of slots for MCSt.” The L1 may report a set of candidate multi-slot resources (S_{A}) in accordance with some or all of the existing L1 resource allocation process. The higher layer may select a candidate multi-slot resource for MCSt.

In some cases, to ensure a quality of service (QOS) for a sidelink communication (for example, latency or reliability requirements), one or more conditions may be identified for MCSt transmissions for resource allocation mode 2 at a network node. In Mode 2 resource allocation, the higher layer (e.g., the MAC layer) may indicate a “number of consecutive slots for MCSt” (N_{slot,MCSt}) that is larger than 1 for L1 reporting multi-slots candidates to the higher layer. The candidate multi-slots resource definition is applied. Otherwise, a candidate single-slot resource definition is applied. The higher layer (e.g., the MAC layer) may select resources from the reported resources according to one of the following examples (e.g., in accordance with a UE implementation). In a first example, the higher layer may select the resources using a random selection. In a second example, the higher layer is not restricted to select the resources at random, and can select in consecutive slots. In a third example, once the higher layer selects a multi-slots candidate from the set, the higher layer may use all of the single-slot resources of the selected multi-slots candidate for transmission.

A selected sidelink grant (for example, sl_grant1) with selected resource(s) (for example, R with a slot for initial transmission and one or more slots for retransmission of a transport block, or multiple slots with SPS reservation for periodic transport blocks' transmissions) may be associated with a sidelink process (for example, sl_process1) by a HARQ entity corresponding to a HARQ buffer or data buffer with a single transport block transmission or multiple SPS transport block transmissions. In some cases, a selected sidelink grant with a selected multi-slot resource may be associated with a sidelink process by a HARQ entity corresponding to a HARQ buffer or data buffer that is for a single transport block transmission and one or more associated retransmissions.

As shown by reference number 405, a physical (PHY) layer may perform resource sensing. The MAC layer may obtain data in one or more logical channels, which may trigger resource selection from a set of candidate resources (S_{A}) generated by PHY layer. As shown by reference number 410, the MAC layer may create a selected sidelink grant, for example, in accordance with selecting resource(s) R for the logical channel(s) with data available for transmission(s). The MAC layer may generate a selected sidelink grant (sl_grant1) with the selected resource(s). As shown by reference number 415, the MAC layer may perform logical channel multiplexing using the selected sidelink grant. The MAC layer may generate a MAC PDU (TB1) in accordance with the logical channel multiplexing. As shown by reference number 420, the MAC layer may associate a sidelink process (sl_process1) with the selected sidelink grant and the MAC PDU (TB1) by HARQ entity. The MAC layer may provide, to the PHY layer, a PSCCH or PSSCH for transmitting the MAC PDU (TB1). As shown by reference number 425, the PHY layer may perform an LBT procedure to access channel for transmitting the PSCCH or the PSSCH. The PHY layer may perform a transmission using the PSCCH or the PSCCH after an LBT with channel accessing success.

In some cases, a sidelink grant for a multi-slot resource may include one or more unused resources (for example, one or more unused slots). For example, the sidelink grant may indicate a resource that includes six slots. A first slot and a second slot may be used for performing LBT with channel accessing failures (e.g., two failed LBTs), and a third slot may be used for a transmission of a transport block after the LBT with channel accessing success (e.g., a successful LBT). However, the three remaining slots may not be needed for the transport block to be transmitted, and therefore, may be unused by the sidelink UE. This may result in a waste of network resources. In some examples, the unused slots may be used for performing one or more retransmissions of the transport block. However, the retransmission(s) may not be needed, for example, when channel conditions are reliable.

As indicated above, FIG. 4 is provided as an example. Other examples may differ from what is described with respect to FIG. 4.

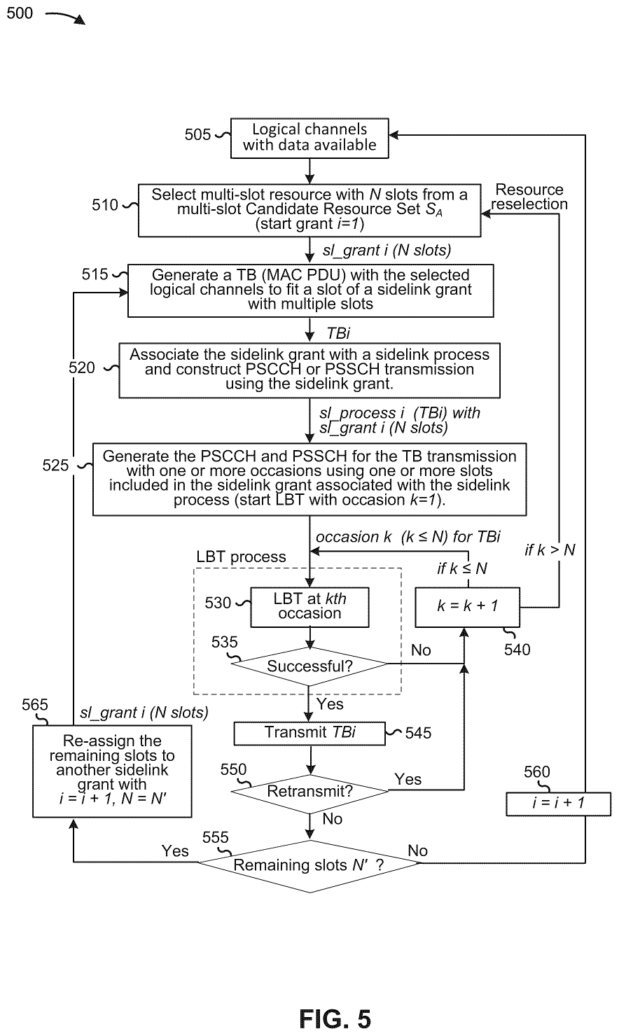

FIG. 5 is a diagram illustrating an example 500 of multi-slot resource allocation, in accordance with the present disclosure. The UE 120 may communicate with one or more other UEs or devices via a sidelink communication channel.

As shown by reference number 505, the UE 120 may select one or more logical channels. For example, the UE 120 may have one or more logical channels with available data for transmission which may trigger a resource selection process for the one or more logical channels.

As shown by reference number 510, the UE 120 may select a multi-slot resource. For example, the UE 120 may perform a resource selection process for selecting a multi-slot resource from a multi-slot candidate resource set (S_{A}). The multi-slot resource may be a resource that include N consecutive slots. The selected multi-slot resource may include a plurality of consecutive slots for a first sidelink grant. The multi-slot resource may be associated with a sidelink grant sl_grant; that is assigned or associated with N consecutive slots, where i starts at 1 for the first sidelink grant.

As shown by reference number 515, the UE 120 may generate a transport block. The UE 120 may perform a logical channel multiplexing for the selected logical channels, for example, in accordance with a priority (e.g., select the logical channel(s) with highest priority), a sidelink CAPC (e.g., select the logical channel(s) with a sidelink CAPC value), a COT sharing indication (e.g., select the logical channel(s) associated with the destination ID indicated implicitly or explicitly by a COT indication for sharing the COT), or a destination (e.g., select the other logical channel(s) with the same destination ID as the first logical channel selected), among other examples, for MCSt. The UE 120 may generate the transport block (a MAC PDU) with the selected logical channel(s) and/or a MAC control element (MAC-CE) that fits into a slot of the sidelink grant with the plurality of slots (e.g., a first slot included in the sl_grantᵢ that is assigned or associated with the N consecutive slots). The MAC-CE may be a channel state information (CSI) report MAC-CE or may be an inter-UE coordination (IUC) request or IUC information MAC-CE, among other examples.

As shown by reference number 520, the UE 120 may associate the sidelink grant with a sidelink process and may construct a PSCCH transmission or a PSSCH transmission using the first sidelink grant. For example, the UE 120 may associate the sidelink grant (sl_grantᵢ) with a sidelink process (sl_processᵢ) via a HARQ entity, and may construct a PSCCH transmission or a PSSCH transmission using at least one slot of the sl_grantᵢ that is assigned or associated with the N consecutive slots (e.g., at least one transmission occasion based on the N consecutive slots in the sl_grantᵢ).

As shown by reference number 525, the UE 120 may form the PSCCH and the PSSCH for transmitting the transport block at the one or more transmission occasions or one or more LBT occasions using one or more slots of the plurality of slots included in the first sidelink grant associated with the sidelink process. In this example, the MAC layer may instruct the PHY layer to start the LBT with occasion k|ₖ₌₁ (e.g., start at the first occasion corresponding to the first slot in the first sidelink grant).

As shown by reference number 530, the UE 120 may initiate the LBT process at a kth LBT occasion (or transmission occasion k) associated with the kth slot of the plurality of slots (e.g., N slots) assigned to the first sidelink grant. For example, the UE 120 may initiate the LBT process at an LBT occasion with k=1 (e.g., at the first occasion corresponding to the first slot).

As shown by reference number 535, the UE 120 may identify whether the LBT process performed at the kth LBT occasion was successful.

As shown by reference number 540, if the LBT process performed at the kth LBT occasion was not successful, the UE 120 may increment k (k=k+1). If the incremented k is less than or equal to N (k≤N) (e.g., with remaining slot(s) available with the sidelink grant), the UE 120 may perform another LBT at the next transmission or LBT occasion k|ₖ₌ₖ₊₁. For example, the UE 120 may perform another LBT at occasion k|ₖ₌ₖ₊₁ (e.g., the next occasion k|ₖ₌ₖ₊₁ corresponding to the next slot k|ₖ₌ₖ₊₁), where k+1≤N corresponding to the first available slot of the remaining slots (e.g., the remaining slots N′, where N′=[k+1, N] included). Alternatively, if the incremented k is greater than N (k>N) (e.g., beyond the total slots assigned with the sidelink grant sl_grantᵢ), the UE 120 may perform a resource selection (e.g., as described in connection with reference number 510).

As shown by reference number 545, if the LBT performed at the kth transmission or LBT occasion was successful, the UE 120 may transmit the transport block (TBi) at this occasion (e.g., transmitted at the kth slot of the sidelink grant sl_grantᵢ).

As shown by reference number 550, the UE 120 may identify whether to perform a retransmission of the transport block. For example, the UE 120 may determine whether blind transmission is enabled. If the UE 120 determines to perform the retransmission of the transport block, the UE 120 may increment k (k=k+1) for the next transmission occasion with or without LBT. If the subsequent transmission can form a transmission burst (e.g., with a gap between adjacent transmissions up to a limit such as 16 microseconds), then no LBT is performed before the retransmission. Alternatively, if the subsequent transmission cannot form a transmission burst, LBT (e.g., Type-2 LBT with reduced LBT overhead for COT sharing) may be performed before the retransmission (e.g., with a gap between adjacent transmissions up to another limit such as 25 microseconds).

As shown by reference number 555, the UE 120 may determine whether there are any remaining slots N′ assigned to or associated with the sidelink grant (sl_grantᵢ).

As shown by reference number 560, if there are not any remaining slots assigned to or associated with the sidelink grant, the UE 120 may increment i (i=i+1) and may identify whether any logical channel with data are available for transmission (e.g., as described in connection with reference number 505).

As shown by reference number 565, if there is at least one remaining slot assigned to the sidelink grant, the UE 120 may re-assign the remaining slots to another sidelink grant (e.g., sl_grant i|ᵢ₌ᵢ₊₁) with i=i+1 and N=N′ and may generate another transport block with one or more logical channels selected (e.g., as described in connection with reference number 515) using the other sidelink grant. Therefore, the remaining slots assigned to the first sidelink grant (sl_grantᵢ) of the multi-slot resource for a first transport block (TBᵢ) may be re-assigned to a second sidelink grant (sl_grant i|ᵢ₌ᵢ₊₁) for a second transport block (TB i|ᵢ₌ᵢ₊₁), where the first sidelink process associated with the first sidelink grant may be released with the associated HARQ buffer or data buffer flushed and a second sidelink process (sl_process i|ᵢ₌ᵢ₊₁) may be associated with the second sidelink grant (sl_grant i|ᵢ₌ᵢ₊₁) for the second transport block (TB i|ᵢ₌ᵢ₊₁) (e.g., as described in connection with reference number 520). Additionally, as described in connection with reference number 520, a second PSCCH and PSSCH may be formed for the second transport block (TB i|ᵢ₌ᵢ₊₁) with one or more occasions using the one or more slots included in the second sidelink grant (sl_grant i|ᵢ₌ᵢ₊₁). As described in connection with reference numbers 530 and 535, if the subsequent transmission of the second transport block (TB i|ᵢ₌ᵢ₊₁) can form a transmission burst (e.g., with a gap after the first transport block's transmission or last retransmission up to a limit such as 16 microseconds), then no LBT is performed before the transmission of the second transport block (TB i|ᵢ₌ᵢ₊₁). Alternatively, if the subsequent transmission of the second transport block (TB i|ᵢ₌ᵢ₊₁) cannot form a transmission burst, LBT (e.g., Type-2 LBT with reduced LBT overhead for COT sharing) may be performed before the transmission of the second transport block (TB i|ᵢ₌ᵢ₊₁) (e.g., with a gap after the first transport block's transmission or last retransmission up to another limit such as 25 microseconds). Additionally, as shown by reference number 565, if there is at least one remaining slot assigned to the sidelink grant (e.g., the second sidelink grant), the UE 120 may re-assign the remaining slots to another sidelink grant (e.g., a third sidelink grant sl_grant i|ᵢ₌ᵢ₊₁) with i=i+1 and N=N′ and may generate another transport block (e.g., a third transport block TB i|ᵢ₌ᵢ₊₁) with one or more logical channels selected (e.g., as described in connection with reference number 515) using the other sidelink grant (e.g., the third sidelink grant sl_grant i|ᵢ₌ᵢ₊₁).

As indicated above, FIG. 5 is provided as an example. Other examples may differ from what is described with respect to FIG. 5.

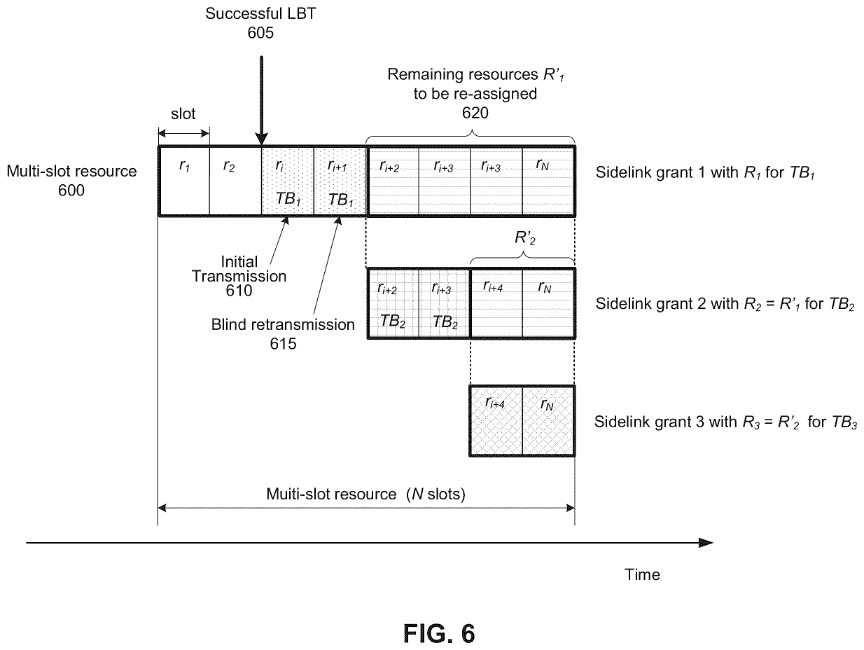

FIG. 6 is a diagram illustrating an example of a multi-slot resource 600, in accordance with the present disclosure. The multi-slot resource 600 may be a resource that includes a plurality of consecutive slots. For example, the multi-slot resource may include eight consecutive slots beginning with a first slot (r₁). The UE 120 may start the first LBT at the first occasion corresponding to the first slot, then continue with a second LBT at the second occasion corresponding to the second slot after failed the first LBT. As shown by reference number 605, the UE 120 may perform a successful LBT corresponding to the ith slot (rᵢ) (e.g., the third slot) of the multi-slot resource 600. As shown by reference number 610, the UE 120 may perform an initial transmission of a first transport block (TB₁) at the ith slot (rᵢ) after the successful LBT. The UE 120 may perform the initial transmission of the first transport block in accordance with a first sidelink grant (sidelink grant 1) and using first resource set (R₁) that includes remaining six consecutive slots rᵢ, rᵢ₊₁, rᵢ₊₂, rᵢ₊₃, rᵢ₊₄, and r_{N}. In this example, the UE 120 may perform the initial transmission of the first transport block in slot (rᵢ) of the resource set R₁ associated with the first sidelink grant. As shown by reference number 615, the UE 120 may perform a retransmission (e.g., a blind retransmission) of the first transport block. The UE 120 may perform the retransmission of the first transport block in slot (rᵢ₊₁) of the first resource set R₁ associated with the first sidelink grant. As shown by reference number 620, the remaining resources (e.g., the unused resources that occur after the retransmission of the first transport block) of the multi-slot resource 600 may be reassigned. For example, the remaining resources of the first resource set (R′₁) associated with the first sidelink grant (sidelink grant 1) may be reassigned to a second resource set (R₂) associated with a second sidelink grant (sidelink grant 2) for transmitting a second transport block (TB₂). The second sidelink grant (sidelink grant 2) may include the second resource set (R₂), where the second resource set (R₂) includes the remaining resources of the first resource set (R′₁). Thus, resources rᵢ₊₂, rᵢ₊₃, rᵢ₊₄, and r_{N} may be reassigned from the first resource set (R₁) to the second resource set (R₂) for transmitting the second transport block (TB₂) in accordance with the second sidelink grant. The UE 120 may transmit the second transport block at resource rᵢ₊₂ and may perform a retransmission of the second transport block at rᵢ₊₃. In some aspects, the remaining resources (e.g., the unused resources after the retransmission of the second transport block) of the multi-slot resource 600 may be reassigned. For example, the remaining resources of the second resource set (R′₂) associated with the second sidelink grant (sidelink grant 2) may be reassigned to a third resource set (R₃) associated with a third sidelink grant (sidelink grant 3) for transmitting a third transport block (TB₃). The third sidelink grant (sidelink grant 3) may include the third resource set (R₃), where the third resource set (R₃) includes the remaining resources of the second resource set (R′₂). Thus, resources rᵢ₊₄, and r_{N} may be reassigned from the second resource set (R₂) to the third resource set (R₃) for transmitting the third transport block (TB₃) in accordance with the third sidelink grant. The UE 120 may transmit the third transport block at resource rᵢ₊₄ and may perform a retransmission of the third transport block at r_{i+N}.

As indicated above, FIG. 6 is provided as an example. Other examples may differ from what is described with respect to FIG. 6.

Additionally, or alternatively, in the case of that multiple single-slot resources are adjacent to each other in time within a single-slot candidate resource set, the UE 120 may select a first single-slot resource for a first sidelink grant and may assemble a first TB to transmit using the first sidelink grant. The UE 120 may select a second single-slot resource that immediately follows the first single-slot resource (if available in the single-slot candidate resource set S_{A}) for a second sidelink grant and may assemble a second TB to transmit using the second sidelink grant for best effort MCSt (e.g., some single-slot resources are adjacent to each other in the single-slot candidate resource set S_{A}).

FIG. 7 is a diagram illustrating an example process 700 performed, for example, at a UE or an apparatus of a UE, in accordance with the present disclosure. Example process 700 is an example where the apparatus or the UE (e.g., UE 120) performs operations associated with multi-slot resource allocation.

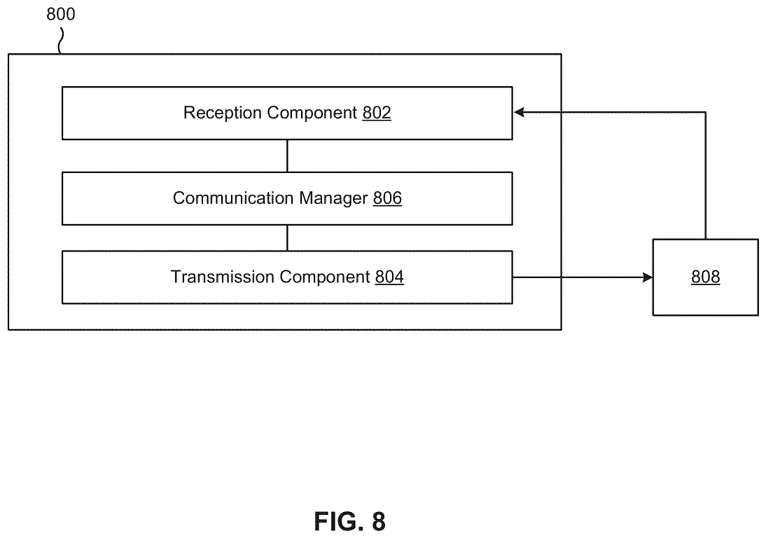

As shown in FIG. 7, in some aspects, process 700 may include performing an LBT process for a multi-slot resource that includes a plurality of consecutive slots (block 710). For example, the UE (e.g., using communication manager 806, depicted in FIG. 8) may perform an LBT process for a multi-slot resource that includes a plurality of consecutive slots, as described above.

As further shown in FIG. 7, in some aspects, process 700 may include transmitting, based at least in part on the LBT process, a first transport block within a slot of the multi-slot resource in accordance with a first sidelink grant that includes the multi-slot resource (block 720). For example, the UE (e.g., using transmission component 804 and/or communication manager 806, depicted in FIG. 8) may transmit, based at least in part on the LBT process, a first transport block within a slot of the multi-slot resource in accordance with a first sidelink grant that includes the multi-slot resource, as described above.

As further shown in FIG. 7, in some aspects, process 700 may include assigning one or more other slots of the multi-slot resource to a second sidelink grant for transmitting a second transport block (block 730). For example, the UE (e.g., using communication manager 806, depicted in FIG. 8) may assign one or more other slots of the multi-slot resource to a second sidelink grant for transmitting a second transport block, as described above.

Process 700 may include additional aspects, such as any single aspect or any combination of aspects described below and/or in connection with one or more other processes described elsewhere herein.

In a first aspect, process 700 includes selecting the multi-slot resource from a plurality of multi-slot resources included in a multi-slot candidate resource set.

In a second aspect, alone or in combination with the first aspect, process 700 includes multiplexing one or more logical channels using at least one of a priority, a channel access priority class, a channel occupancy time sharing condition, or a destination associated with a multi-consecutive slot transmission configuration, and generating the first transport block using at least one of the one or more logical channels or control information.

In a third aspect, alone or in combination with one or more of the first and second aspects, the first transport block is a medium access control protocol data unit, wherein the control information is included in a MAC control element, and wherein the first transport block fits into the slot of the multi-slot resource in accordance with the first sidelink grant.

In a fourth aspect, alone or in combination with one or more of the first through third aspects, process 700 includes associating the first sidelink grant with a sidelink process via a HARQ entity, and generating a PSCCH transmission occasion or a PSSCH transmission occasion in accordance with the first sidelink grant, wherein transmitting the first transport block within the slot of the multi-slot resource comprises transmitting the first transport block using at least one of the PSCCH transmission occasion or the PSSCH transmission occasion in accordance with the first sidelink grant.

In a fifth aspect, alone or in combination with one or more of the first through fourth aspects, process 700 includes providing, by a medium access control layer to a physical layer, an instruction to transmit the first transport block using the PSCCH transmission occasion or the PSSCH transmission occasion.

In a sixth aspect, alone or in combination with one or more of the first through fifth aspects, performing the LBT process comprises performing the LBT process at a first LBT occasion within the slot of the multi-slot resource.

In a seventh aspect, alone or in combination with one or more of the first through sixth aspects, process 700 includes detecting an LBT failure occurrence at the first LBT occasion.

In an eighth aspect, alone or in combination with one or more of the first through seventh aspects, process 700 includes identifying a second LBT occasion associated within a subsequent available slot of the multi-slot resource, and performing the LBT process at the second LBT occasion.

In a ninth aspect, alone or in combination with one or more of the first through eighth aspects, process 700 includes identifying that the first LBT occasion is a last LBT occasion associated with the multi-slot resource, and selecting another multi-slot resource for performing another LBT process.

In a tenth aspect, alone or in combination with one or more of the first through ninth aspects, transmitting the first transport block comprises transmitting the first transport block in accordance with detecting an LBT success for the LBT process.

In an eleventh aspect, alone or in combination with one or more of the first through tenth aspects, process 700 includes performing a retransmission of the first transport block in accordance with identifying that blind retransmission is enabled and in accordance with identifying that a transmission burst can be generated.

In a twelfth aspect, alone or in combination with one or more of the first through eleventh aspects, process 700 includes performing another LBT process for a retransmission of the first transport block in accordance with identifying that blind retransmission is enabled and in accordance with identifying that a transmission burst cannot be generated.

In a thirteenth aspect, alone or in combination with one or more of the first through twelfth aspects, assigning the one or more other slots of the multi-slot resource to the second sidelink grant comprises assigning the one or more other slots of the multi-slot resource to the second sidelink grant in accordance with identifying that a retransmission of the first transport block is not enabled.

In a fourteenth aspect, alone or in combination with one or more of the first through thirteenth aspects, process 700 includes identifying, after transmitting the first transport block within the slot of the multi-slot resource, that the first sidelink grant is assigned at least one remaining slot of the multi-slot resource.

In a fifteenth aspect, alone or in combination with one or more of the first through fourteenth aspects, assigning the one or more other slots of the multi-slot resource to the second sidelink grant comprises reassigning the at least one remaining slot assigned to the first sidelink grant to the second sidelink grant based at least in part on the first sidelink grant being assigned the at least one remaining slot.

In a sixteenth aspect, alone or in combination with one or more of the first through fifteenth aspects, process 700 includes transmitting the second transport block, and searching for logical channels based at least in part on the first sidelink grant not being assigned any remaining slots of the multi-slot resource after transmitting the second transport block.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication, in accordance with the present disclosure. The apparatus 800 may be a UE, or a UE may include the apparatus 800. In some aspects, the apparatus 800 includes a reception component 802, a transmission component 804, and/or a communication manager 806, which may be in communication with one another (for example, via one or more buses and/or one or more other components). In some aspects, the communication manager 806 is the communication manager 140 described in connection with FIG. 1. As shown, the apparatus 800 may communicate with another apparatus 808, such as a UE or a network node (such as a CU, a DU, an RU, or a base station), using the reception component 802 and the transmission component 804.

In some aspects, the apparatus 800 may be configured to perform one or more operations described herein in connection with FIGS. 5-6. Additionally, or alternatively, the apparatus 800 may be configured to perform one or more processes described herein, such as process 700 of FIG. 7. In some aspects, the apparatus 800 and/or one or more components shown in FIG. 8 may include one or more components of the UE described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 808. In some aspects, the transmission component 804 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 804 may be co-located with the reception component 802 in one or more transceivers.

The communication manager 806 may support operations of the reception component 802 and/or the transmission component 804. For example, the communication manager 806 may receive information associated with configuring reception of communications by the reception component 802 and/or transmission of communications by the transmission component 804. Additionally, or alternatively, the communication manager 806 may generate and/or provide control information to the reception component 802 and/or the transmission component 804 to control reception and/or transmission of communications.

The communication manager 806 may perform an LBT process for a multi-slot resource that includes a plurality of consecutive slots. The transmission component 804 may transmit, based at least in part on the LBT process, a first transport block within a slot of the multi-slot resource in accordance with a first sidelink grant that includes the multi-slot resource. The communication manager 806 may assign one or more other slots of the multi-slot resource to a second sidelink grant for transmitting a second transport block.

The communication manager 806 may select the multi-slot resource from a plurality of multi-slot resources included in a multi-slot candidate resource set. The communication manager 806 may multiplex one or more logical channels using at least one of a priority, a channel access priority class, a channel occupancy time sharing condition, or a destination associated with a multi-consecutive slot transmission configuration. The communication manager 806 may generate the first transport block using at least one of the one or more logical channels or control information. The communication manager 806 may associate the first sidelink grant with a sidelink process via a HARQ entity. The communication manager 806 may generate a PSCCH transmission occasion or a PSSCH transmission occasion in accordance with the first sidelink grant, wherein transmitting the first transport block within the slot of the multi-slot resource comprises transmitting the first transport block using at least one of the PSCCH transmission occasion or the PSSCH transmission occasion in accordance with the first sidelink grant. The communication manager 806 may provide an instruction to transmit the first transport block using the PSCCH transmission occasion or the PSSCH transmission occasion.

The communication manager 806 may detect an LBT failure occurrence at the first LBT occasion. The communication manager 806 may identify a second LBT occasion associated within a subsequent available slot of the multi-slot resource. The communication manager 806 may perform the LBT process at the second LBT occasion. The communication manager 806 may identify that the first LBT occasion is a last LBT occasion associated with the multi-slot resource. The communication manager 806 may select another multi-slot resource for performing another LBT process. The communication manager 806 may perform a retransmission of the first transport block in accordance with identifying that blind retransmission is enabled and in accordance with identifying that a transmission burst can be generated. The communication manager 806 may perform another LBT process for a retransmission of the first transport block in accordance with identifying that blind retransmission is enabled and in accordance with identifying that a transmission burst cannot be generated. The communication manager 806 may identify, after transmitting the first transport block within the slot of the multi-slot resource, that the first sidelink grant is assigned at least one remaining slot of the multi-slot resource. The transmission component 804 may transmit the second transport block. The communication manager 806 may search for logical channels based at least in part on the first sidelink grant not being assigned any remaining slots of the multi-slot resource after transmitting the second transport block.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

The following provides an overview of some Aspects of the present disclosure:

Aspect 1: A method of wireless communication performed by a user equipment (UE), comprising: performing a listen-before-talk (LBT) process for a multi-slot resource that includes a plurality of consecutive slots; transmitting, based at least in part on the LBT process, a first transport block within a slot of the multi-slot resource in accordance with a first sidelink grant that includes the multi-slot resource; and assigning one or more other slots of the multi-slot resource to a second sidelink grant for transmitting a second transport block.

Aspect 2: The method of Aspect 1, further comprising selecting the multi-slot resource from a plurality of multi-slot resources included in a multi-slot candidate resource set.

Aspect 3: The method of any of Aspects 1-2, further comprising: multiplexing one or more logical channels using at least one of a priority, a channel access priority class, a channel occupancy time sharing condition, or a destination associated with a multi-consecutive slot transmission configuration; and generating the first transport block using at least one of the one or more logical channels or control information.

Aspect 4: The method of Aspect 3, wherein the first transport block is a medium access control protocol data unit, wherein the control information is included in a medium access control (MAC) control element, and wherein the first transport block fits into the slot of the multi-slot resource in accordance with the first sidelink grant.

Aspect 5: The method of any of Aspects 1-4, further comprising: associating the first sidelink grant with a first sidelink process via a hybrid automatic repeat request (HARQ) entity; and generating one or more physical sidelink control channel (PSCCH) transmission occasions and one or more physical sidelink shared channel (PSSCH) transmission occasions in accordance with the first sidelink grant, wherein transmitting the first transport block within the slot of the multi-slot resource comprises transmitting the first transport block using at least one of the one or more PSCCH transmission occasions and the one or more PSSCH transmission occasions in accordance with the first sidelink grant.

Aspect 6: The method of Aspect 5, further comprising providing an instruction to transmit the first transport block using the one or more PSCCH transmission occasions and the one or more PSSCH transmission occasions.

Aspect 7: The method of any of Aspects 1-6, wherein performing the LBT process comprises performing the LBT process at a first LBT occasion within the slot of the multi-slot resource.

Aspect 8: The method of Aspect 7, further comprising detecting an LBT failure occurrence at the first LBT occasion.

Aspect 9: The method of Aspect 8, further comprising: identifying a second LBT occasion associated within a subsequent available slot of the multi-slot resource; and performing the LBT process at the second LBT occasion.

Aspect 10: The method of Aspect 8, further comprising: identifying that the first LBT occasion is a last LBT occasion associated with the multi-slot resource; and selecting another multi-slot resource for performing another LBT process.

Aspect 11: The method of Aspect 7, wherein transmitting the first transport block comprises transmitting the first transport block in accordance with detection of an LBT success for the LBT process.

Aspect 12: The method of any of Aspects 1-11, further comprising performing a retransmission of the first transport block in accordance with blind retransmission being enabled and in accordance with a transmission burst being able to be generated.

Aspect 13: The method of any of Aspects 1-12, further comprising performing another LBT process for a retransmission of the first transport block in accordance with blind retransmission being enabled and in accordance with a transmission burst not being able to be generated.

Aspect 14: The method of any of Aspects 1-13, wherein assigning the one or more other slots of the multi-slot resource to the second sidelink grant comprises assigning the one or more other slots of the multi-slot resource to the second sidelink grant in accordance with a retransmission of the first transport block not being enabled.

Aspect 15: The method of any of Aspects 1-14, further comprising identifying, after the first transport block is transmitted within the slot of the multi-slot resource, that the first sidelink grant is assigned at least one remaining slot of the multi-slot resource.

Aspect 16: The method of Aspect 15, wherein assigning the one or more other slots of the multi-slot resource to the second sidelink grant comprises reassigning the at least one remaining slot assigned to the first sidelink grant to the second sidelink grant based at least in part on the first sidelink grant being assigned the at least one remaining slot.

Aspect 17: The method of any of Aspects 1-16, further comprising: transmitting the second transport block using the second sidelink grant; and identifying logical channels with data available for triggering a selection of another multi-slot resource based at least in part on the second sidelink grant not being assigned any remaining slots of the multi-slot resource after the second transport block is transmitted.

Aspect 18: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-17.

Aspect 19: An apparatus for wireless communication at a device, the apparatus comprising one or more memories and one or more processors coupled to the one or more memories, the one or more processors configured to cause the device to perform the method of one or more of Aspects 1-17.

Aspect 20: An apparatus for wireless communication, the apparatus comprising at least one means for performing the method of one or more of Aspects 1-17.

Aspect 21: A non-transitory computer-readable medium storing code for wireless communication, the code comprising instructions executable by one or more processors to perform the method of one or more of Aspects 1-17.

Aspect 22: A non-transitory computer-readable medium storing a set of instructions for wireless communication, the set of instructions comprising one or more instructions that, when executed by one or more processors of a device, cause the device to perform the method of one or more of Aspects 1-17.

Aspect 23: A device for wireless communication, the device comprising a processing system that includes one or more processors and one or more memories coupled with the one or more processors, the processing system configured to cause the device to perform the method of one or more of Aspects 1-17.

Aspect 24: An apparatus for wireless communication at a device, the apparatus comprising one or more memories and one or more processors coupled to the one or more memories, the one or more processors individually or collectively configured to cause the device to perform the method of one or more of Aspects 1-17.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.” As used herein, “satisfying a threshold” may, depending on the context, refer to a value being greater than the threshold, greater than or equal to the threshold, less than the threshold, less than or equal to the threshold, equal to the threshold, or not equal to the threshold, among other examples. As used herein, a phrase referring to “at least one of” a list of items refers to any combination of those items, including single members. As an example, “at least one of: a, b, or c” is intended to cover: a, b, c, a+b, a+c, b+c, and a+b+c.

Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (for example, related items, unrelated items, or a combination of related and unrelated items), and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A also may have B). Further, as used herein, the term “or” is intended to be inclusive when used in a series and may be used interchangeably with “and/or,” unless explicitly stated otherwise (for example, if used in combination with “either” or “only one of”).

The various illustrative logics, logical blocks, modules, circuits and algorithm processes described in connection with the aspects disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Aspects of the subject matter described in this specification also can be implemented as one or more computer programs (such as one or more modules of computer program instructions) encoded on a computer storage media for execution by, or to control the operation of, a data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the media described herein should also be included within the scope of computer-readable media. Additionally, the operations of a method or algorithm may reside as one or any combination or set of codes and instructions on a machine readable medium and computer-readable medium, which may be incorporated into a computer program product.

Various modifications to the aspects described in this disclosure may be readily apparent to those skilled in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate aspects also can be implemented in combination in a single aspect. Conversely, various features that are described in the context of a single aspect also can be implemented in multiple aspects separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the aspects described should not be understood as requiring such separation in all aspects, and it should be understood that the described program components and systems can generally be integrated together in a single software product or packaged into multiple software products. Additionally, other aspects are within the scope of the following claims. In some cases, the actions recited in the claims can be performed in a different order and still achieve desirable results.

What is claimed is:

1. An apparatus for wireless communication, comprising:
one or more memories; and
one or more processors coupled to the one or more memories, the one or more processors individually or collectively configured to:
perform a listen-before-talk (LBT) process for a multi-slot resource that includes a plurality of consecutive slots;
transmit, based at least in part on the LBT process, a first transport block within a slot of the multi-slot resource in accordance with a first sidelink grant that includes the multi-slot resource; and
assign one or more other slots of the multi-slot resource to a second sidelink grant for transmitting a second transport block.

2. The apparatus of claim 1, wherein the one or more processors are further configured to select the multi-slot resource from a plurality of multi-slot resources included in a multi-slot candidate resource set.

3. The apparatus of claim 1, wherein the one or more processors are further configured to:
multiplex one or more logical channels using at least one of a priority, a channel access priority class, a channel occupancy time sharing condition, or a destination associated with a multi-consecutive slot transmission configuration; and
generate the first transport block using at least one of the one or more logical channels or control information.

4. The apparatus of claim 3, wherein the first transport block is a medium access control protocol data unit, wherein the control information is included in a medium access control (MAC) control element, and wherein the first transport block fits into the slot of the multi-slot resource in accordance with the first sidelink grant.

5. The apparatus of claim 1, wherein the one or more processors are further configured to:
associate the first sidelink grant with a first sidelink process via a hybrid automatic repeat request (HARQ) entity; and
generate one or more physical sidelink control channel (PSCCH) transmission occasions and one or more physical sidelink shared channel (PSSCH) transmission occasions in accordance with the first sidelink grant,
wherein the one or more processors, to transmit the first transport block within the slot of the multi-slot resource, are configured to transmit the first transport block using at least one of the one or more PSCCH transmission occasions and the one or more PSSCH transmission occasions in accordance with the first sidelink grant.

6. The apparatus of claim 5, wherein the one or more processors are further configured to provide an instruction to transmit the first transport block using the one or more PSCCH transmission occasions and the one or more PSSCH transmission occasions.

7. The apparatus of claim 1, wherein the one or more processors, to perform the LBT process, are configured to perform the LBT process at a first LBT occasion within the slot of the multi-slot resource.

8. The apparatus of claim 7, wherein the one or more processors are further configured to detect an LBT failure occurrence at the first LBT occasion.

9. The apparatus of claim 8, wherein the one or more processors are further configured to:
identify a second LBT occasion associated within a subsequent available slot of the multi-slot resource; and
perform the LBT process at the second LBT occasion.

10. The apparatus of claim 8, wherein the one or more processors are further configured to:
identify that the first LBT occasion is a last LBT occasion associated with the multi-slot resource; and
select another multi-slot resource for performing another LBT process.

11. The apparatus of claim 7, wherein the one or more processors, to transmit the first transport block, are configured to transmit the first transport block in accordance with detection of an LBT success for the LBT process.

12. The apparatus of claim 1, wherein the one or more processors are further configured to perform a retransmission of the first transport block in accordance with blind retransmission being enabled and in accordance with a transmission burst being able to be generated.

13. The apparatus of claim 1, wherein the one or more processors are further configured to perform another LBT process for a retransmission of the first transport block in accordance with blind retransmission being enabled and in accordance with a transmission burst not being able to be generated.

14. The apparatus of claim 1, wherein the one or more processors, to assign the one or more other slots of the multi-slot resource to the second sidelink grant, are configured to assign the one or more other slots of the multi-slot resource to the second sidelink grant in accordance with a retransmission of the first transport block not being enabled.

15. The apparatus of claim 1, wherein the one or more processors are further configured to identify, after the first transport block is transmitted within the slot of the multi-slot resource, that the first sidelink grant is assigned at least one remaining slot of the multi-slot resource.

16. The apparatus of claim 15, wherein the one or more processors, to assign the one or more other slots of the multi-slot resource to the second sidelink grant, are configured to reassign the at least one remaining slot assigned to the first sidelink grant to the second sidelink grant based at least in part on the first sidelink grant being assigned the at least one remaining slot.

17. The apparatus of claim 1, wherein the one or more processors are further configured to:
transmit the second transport block using the second sidelink grant; and
identify logical channels with data available for triggering a selection of another multi-slot resource based at least in part on the second sidelink grant not being assigned any remaining slots of the multi-slot resource after the second transport block is transmitted.

18. A method of wireless communication performed by a user equipment (UE), comprising:
performing a listen-before-talk (LBT) process for a multi-slot resource that includes a plurality of consecutive slots;
transmitting, based at least in part on the LBT process, a first transport block within a slot of the multi-slot resource in accordance with a first sidelink grant that includes the multi-slot resource; and
assigning one or more other slots of the multi-slot resource to a second sidelink grant for transmitting a second transport block.

19. The method of claim 18, further comprising selecting the multi-slot resource from a plurality of multi-slot resources included in a multi-slot candidate resource set.

20. A non-transitory computer-readable medium storing a set of instructions for wireless communication, the set of instructions comprising:
one or more instructions that, when executed by one or more processors of a user equipment (UE), cause the UE to:
perform a listen-before-talk (LBT) process for a multi-slot resource that includes a plurality of consecutive slots;
transmit, based at least in part on the LBT process, a first transport block within a slot of the multi-slot resource in accordance with a first sidelink grant that includes the multi-slot resource; and
assign one or more other slots of the multi-slot resource to a second sidelink grant for transmitting a second transport block.
